(19) United States
(12) Patent Application Publication
(10) Pub. No.: US 2024/0332788 A1
(43) Pub. Date: Oct. 3, 2024

(54) RADOME AND WIRELESS COMMUNICATION SYSTEM

(71) Applicant: HUAWEI TECHNOLOGIES CO., LTD., Shenzhen (CN)

(72) Inventors: Liangyuan LI, Dongguan (CN); Ning YI, Dongguan (CN)

(21) Appl. No.: 18/735,793

(22) Filed: Jun. 6, 2024

Related U.S. Application Data
(63) Continuation of application No. PCT/CN2022/136557, filed on Dec. 5, 2022.

(30) Foreign Application Priority Data
Dec. 8, 2021 (CN) 202111490488.7

(51) Int. Cl. H01Q 1/42

(52) U.S. Cl. CPC H01Q 1/422

(57) ABSTRACT

A radome is provided. The radome includes a substrate layer and a reinforcement layer, and the reinforcement layer is formed at least on an inner surface and/or an outer surface of the substrate layer. The reinforcement layer includes a fiber layer and thermoplastic resin attached to the fiber layer, the fiber layer includes a first fiber, and a length of the first fiber is greater than or equal to 25 mm; and the substrate layer includes thermoplastic resin, and the thermoplastic resin in the reinforcement layer is made of a same material as the thermoplastic resin in the substrate layer. According to the radome provided in this application, the reinforcement layer is provided on the substrate layer, so that impact resistance performance of the entire radome is improved by using the reinforcement layer. This is conducive to implementing lightweight of the radome and meeting an impact resistance performance requirement.

### CROSS-REFERENCE TO RELATED APPLICATIONS

This application is a continuation of International Application No. PCT/CN2022/136557, filed on Dec. 5, 2022, which claims priority to Chinese Patent Application No. 202111490488.7, filed on Dec. 8, 2021. The disclosures of the aforementioned applications are hereby incorporated by reference in their entireties.

### TECHNICAL FIELD

This application relates to the field of wireless communication technologies, and in particular, to a radome and a wireless communication system.

### BACKGROUND

A radome serves as a protective housing of an antenna, to ensure normal operation of an internal component of the antenna. As a quantity of frequency bands, a quantity of channels, and an antenna size of a massive MIMO antenna increase, an antenna system size and an antenna weight increase significantly. The antenna may be impacted by vibration, falling, or the like during bare metal transportation or moving, may be trodden on a mounting site, and may strike a tower due to swinging during mounting and hoisting. All of these pose a high impact resistance performance requirement on the radome. Therefore, how to implement lightweight of the radome while meeting the high impact resistance performance requirement is a problem that an antenna device manufacturer needs to consider.

### SUMMARY

In view of this, this application proposes a radome and a wireless communication system, to improve impact resistance performance of the radome while implementing lightweight of the radome, so as to meet impact resistance performance requirements in an antenna steel ball impact test and hoisting striking.

According to a first aspect, this application provides a radome, where the radome includes a substrate layer and a reinforcement layer, and the reinforcement layer is formed at least on an inner surface and/or an outer surface of the substrate layer.

The reinforcement layer includes a fiber layer and thermoplastic resin attached to the fiber layer, the fiber layer includes a first fiber, and a length of the first fiber is greater than or equal to 25 mm; and the substrate layer includes thermoplastic resin, and the thermoplastic resin in the reinforcement layer is made of a same material as the thermoplastic resin in the substrate layer.

In the foregoing solution, thermoplastic resin composition in the substrate layer of the radome is the same as thermoplastic resin composition in the reinforcement layer of the radome, and the fiber layer is provided on the reinforcement layer. Compared with a single-material structure, in this structure, when the radome is impacted, the fiber layer can absorb higher impact resistance energy, and good stress dispersion effect can be achieved. In addition, the first fiber in the fiber layer is used as a framework of the reinforcement layer, so that a thickness of the radome can be reduced, to implement lightweight.

In a feasible implementation, the reinforcement layer includes at least one of a woven fiber prepreg, a unidirectional fiber prepreg, and a fiber felt prepreg.

The woven fiber prepreg is obtained by impregnating, into the thermoplastic resin, a woven fabric formed by weaving the first fiber. The unidirectional fiber prepreg is obtained as follows: impregnating several first fibers arranged unidirectionally into the thermoplastic resin to form a layer prepreg, and superposing at least two layers of layer prepregs in different directions to form a unidirectional fiber prepreg. The fiber felt prepreg is obtained by impregnating, into the thermoplastic resin, first fibers arranged disorderly. Compared with that in the unidirectional fiber prepreg and the woven fiber prepreg, the first fibers in the fiber felt prepreg are distributed in a more disorderly manner. However, because lengths of the first fibers are greater than or equal to 25 mm, the first fibers of this size can still be used as the framework of the reinforcement layer, so that impact resistance performance of the reinforcement layer can be improved.

In a feasible implementation, the first fiber includes at least one of an inorganic fiber and an organic fiber.

Organic fibers are fibers made of organic polymers or fibers made of natural polymers through chemical processing. Inorganic fibers are chemical fibers made of minerals.

In a feasible implementation, the inorganic fiber includes at least one of a glass fiber, a basalt fiber, an andesite fiber, an aluminum silicate fiber, a boron nitride fiber, an alumina fiber, and a quartz fiber.

In the foregoing solution, the inorganic fiber is characterized by a good mechanical property, small deformation, high use temperature, and excellent chemical stability.

In a feasible implementation, the organic fiber includes at least one of a polypropylene fiber, a polybutylene terephthalate fiber, a polyethylene terephthalate fiber, a poly trimethylene terephthalate fiber, a polyamide fiber, a polyphenylene sulfide fiber, a liquid crystal polymer fiber, a poly-p-phenylene benzobisoxazole fiber, a polybenzimidazole fiber, a polypyridobisinudazole fiber, and a polyimide fiber.

In the foregoing solution, the organic fiber has excellent performance of low density and high impact toughness.

In a feasible implementation, a gram weight of the first fiber is 200 g/m² to 1000 g/m².

In the foregoing solution, if the gram weight of the first fiber is within this range, a weight of the radome can be reduced as a whole, so that the radome has excellent performance of lightweight and impact resistance.

In a feasible implementation, a thickness of the reinforcement layer is 0.2 mm to 1 mm.

Generally, the radome is made of a single thermoplastic resin material by using an injection molding process. Generally, the material includes a modified PP material and a PC material. To meet a requirement in an antenna steel ball impact test and an impact resistance performance requirement in scenarios such as antenna transportation, moving, and mounting, a wall thickness of a main body of the radome is generally greater than 3 mm, so that the weight of the radome is large and it is inconvenient in an actual application process. The thickness of the reinforcement layer of the radome provided in this application is within this range, so that the radome is light.

In a feasible implementation, a thickness of the substrate layer is 0.5 mm to 2 mm.

In the foregoing solution, the substrate layer increases the thickness and rigidity of the radome, and cooperatively reinforces the impact resistance performance of the radome.

In a feasible implementation, the substrate layer further includes a second fiber mixed in the thermoplastic resin, and a length of the second fiber is less than 25 mm

In the foregoing solution, the second fiber may also be used as a framework of the substrate layer, to improve impact resistance performance and a pressure resistance capability of the substrate layer.

In a feasible implementation, the thermoplastic resin includes at least one of polypropylene, polyethylene, polycarbonate, polyethylene terephthalate, polybutylene terephthalate, polyamide, polyphenyleneoxide, polyphenylene sulfide, polyetherimide, and poly(ether-ether-ketone) thermoplastic resin.

In the foregoing solution, the thermoplastic resin is the thermoplastic resin, so that when the substrate layer is combined with the reinforcement layer, fusion between interfaces is better.

In a feasible implementation, the substrate layer is a porous structure, and a pore size of the porous structure is less than or equal to 100 m.

In the foregoing solution, an interior of the substrate layer is the porous structure, so that the weight of the radome is further reduced while ensuring the impact resistance performance.

In a feasible implementation, a porosity of the substrate layer is 10% to 30%.

The porosity of the porous structure is within this range, so that stability of an internal structure of the substrate layer can be ensured. If the porosity of the porous structure is excessively large, a substrate layer structure is easily damaged during an impact process, and a good impact resistance effect cannot be achieved. If the porosity of the porous structure is excessively small, the radome cannot be light.

In a feasible implementation, the substrate layer further includes a hollow microsphere mixed in the thermoplastic resin, a volume proportion of the hollow microsphere in the substrate layer is 10% to 50%, and an average particle size of the hollow microsphere is less than or equal to 50 m.

In the foregoing solution, an interior of the substrate layer is a hollow microsphere structure, so that the weight of the radome is further reduced while ensuring the impact resistance performance.

In a feasible implementation, a weight ratio of the radome to an antenna system is 1:(10 to 50).

In the foregoing solution, a radome produced by using a reinforcement layer of a first fiber-reinforced composite material is characterized by lightweight, and is convenient for an actual mounting process.

According to a second aspect, this application provides a production method for a radome, where the production method includes:
heating a prepreg, to melt and soften thermoplastic resin on a surface of the prepreg;
heating a prepreg, to melt and soften thermoplastic resin on a surface of the prepreg;
placing the softened prepreg into a radome mold, to attach the softened prepreg to an inner wall of at least one side of the radome mold; and
injecting melted thermoplastic resin into the radome mold, where the melted thermoplastic resin is fused with the softened prepreg, and the radome is obtained through cooling.

According to a third aspect, this application provides a wireless communication system, where the wireless communication system includes the radome according to any one of the first aspect or the implementations of the first aspect or a radome obtained according to the production method according to the second aspect.

A technical solution of this application has at least the following beneficial effects.

In the radome provided in this application, the reinforcement layer is provided on the substrate layer. A first fiber framework in the reinforcement layer can absorb higher impact resistance energy, so that the radome can implement good stress dispersion effect when being impacted. The substrate layer increases a thickness and rigidity of the radome, and cooperatively reinforces impact resistance. The thermoplastic resin in the substrate layer has a same composition as the thermoplastic resin in the first fiber-reinforced composite material, and the thermoplastic resin of the same composition has good resin compatibility. Therefore, good interface fusion exists between the substrate layer and the reinforcement layer, a good stress transfer function is achieved, and the substrate layer and the reinforcement layer are not to be layered due to impact energy. Compared with a single-material structure, this composite-structure can reduce a wall thickness of a main body of the radome, implement lightweight, and achieve better impact resistance effect. Further, an interior of the substrate layer is a porous or hollow microsphere structure, to further implement lightweight.

### BRIEF DESCRIPTION OF DRAWINGS

FIG. 1 is a diagram of an architecture of a wireless communication system according to this application;

FIG. 2 is a diagram of a simplified structure of a base station antenna according to an embodiment of this application;

FIG. 3 is a diagram of a cross-sectional structure of a radome according to this application;

FIG. 4 is a diagram of another cross-sectional structure of a radome according to this application;

FIG. 5 is a diagram of still another cross-sectional structure of a radome according to this application;

FIG. 6 is a diagram of an internal structure of a reinforcement layer of a radome according to this application;

FIG. 7 is a diagram of an internal structure of another reinforcement layer of a radome according to this application; and

FIG. 8 is a diagram of an internal structure of still another reinforcement layer of a radome according to this application.

### REFERENCE NUMERALS

10: wireless communication system;
   11: base station;
   12: user equipment;
21: radome;
   211: substrate layer; 212: reinforcement layer; 213: extension part;
22: housing;
   221: sealing chamber; 222: sealing groove;
23: screw;
24: sealing rubber strip.

### DESCRIPTION OF EMBODIMENTS

In descriptions of implementations of this application, it should be understood that a direction or position relationship indicated by terms such as “length”, “thickness”, “upper”, “lower”, “front”, “back”, “left”, “right”, “top”, “bottom”, “inside”, or “outside” is a direction or a position relationship based on the accompanying drawings, and is merely intended to describe the implementations of this application and simplify the descriptions, instead of indicating or implying that an apparatus or an element shall have a specific direction or be formed and operated in a specific direction. Therefore, this shall not be understood as a limitation on the implementations of this application. In addition, terms “first” and “second” are merely intended for a purpose of description, and shall not be understood as an indication or implication of relative importance or implicit indication of a quantity of indicated technical features. Therefore, a feature limited by “first” or “second” may explicitly or implicitly include one or more of the features. In the descriptions of the implementations of this application, “a plurality of” means two or more, unless otherwise specifically limited.

In the descriptions of the implementations of this application, it should be noted that, unless otherwise explicitly specified and limited, a term “connection” should be understood in a broad sense. For example, a connection may be a fixed connection, a detachable connection, or an integrated connection. Alternatively, a connection may be a mechanical connection or an electrical connection, or may mean mutual communication. Alternatively, a connection may be a direct connection, or an indirect connection through an intermediate medium, or may be a connection inside two elements or an interaction relationship between two elements. For a person of ordinary skill in the art, specific meanings of the foregoing terms in the implementations of this application may be understood according to a specific situation.

The following further illustrates some embodiments of this application in detail with reference to the accompanying drawings of this specification.

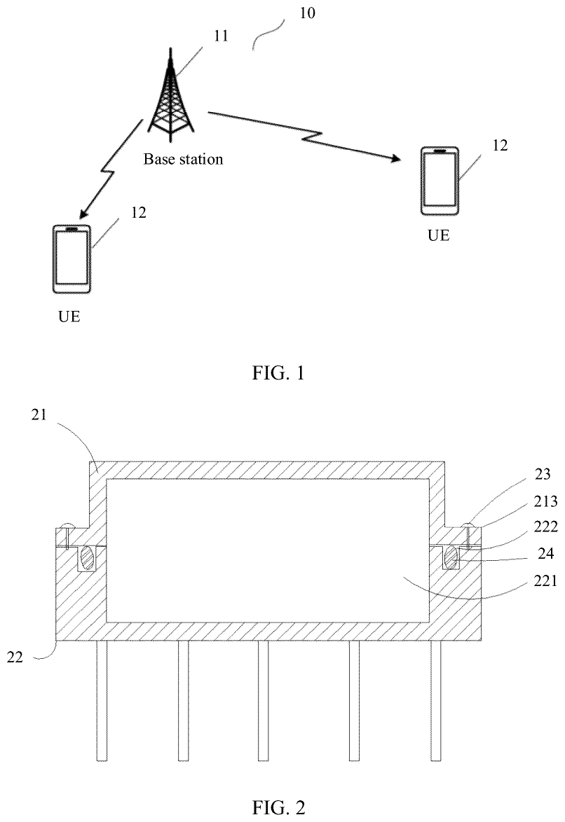

An embodiment of this application provides a wireless communication system 10. FIG. 1 is a diagram of an architecture of a wireless communication system according to an embodiment of this application. As shown in FIG. 1, the wireless communication system 10 may include a base station 11 and user equipment (UE) 12. The base station 11 may communicate with UE 12. It should be noted that the base station and UE that are included in the wireless communication system 10 shown in FIG. 1 are merely examples. In embodiments of this application, the wireless communication system 10 further includes a type of a network element, a quantity of network elements, and a connection relationship between the network elements. This is not limited thereto.

The wireless communication system 10 may be a communication system that supports a fourth generation (4G, Fourth Generation) access technology, for example, an LTE access technology; or the communication system may be a communication system that supports a fifth generation (5G, Fifth Generation) access technology, for example, an NR access technology; or the communication system may be a communication system that supports a plurality of wireless technologies, for example, a communication system that supports an LTE technology and an NR technology. In addition, the communication system is also applicable to a future-oriented communication technology.

The base station 11 in FIG. 1 may be an access network-side device configured to support UE in accessing a wireless communication system, for example, an evolved NodeB (eNB, evolved NodeB) in a communication system of the 4G access technology, or a next generation NodeB (gNB, next-generation NodeB), a transmission/reception point (TRP, Transmission Reception Point), a relay node (Relay Node), or an access point (AP, Access Point) in a communication system of the 5G access technology.

The base station 11 in the wireless communication system 10 is usually disposed on an outdoor or a field stand. In a transportation process, if an antenna mounted on the base station 11 is excessively heavy, it is inconvenient for moving and mounting, and the antenna is likely to be damaged in the transportation process, for example, the antenna is impacted by vibration or falling, or is trodden, or the antenna strikes a tower due to swinging during mounting and hoisting. After mounting is completed, performance of the antenna of the base station 11 is affected by an outdoor environment like a storm, ice and snow, sand and dust, and solar radiation, and further communication quality of the wireless communication system 10 is affected. Therefore, these antennas mounted in the base station 11 need to have lightweight and impact resistance performance. When a radome is in a steel ball impact test and hoisting striking test, a front-face part of the radome bears maximum impact energy.

Currently, the radome is usually made of a single thermoplastic resin material. To meet a requirement in the antenna steel ball impact test and an impact resistance performance requirement in scenarios such as antenna transportation, moving, and mounting, a wall thickness of the radome is generally greater than 3 mm. As an antenna system becomes heavier, the wall thickness of the radome increases correspondingly. Because a length of a glass fiber in pure thermoplastic resin is usually 2 mm to 10 mm, and the glass fiber is further shortened after being cut by a screw of an injection molding machine, an effective length of the glass fiber in a product is less than 5 mm, the glass fiber is randomly distributed and the length of the glass fiber is small, a “framework” function of the glass fiber is small, and a capability of resisting an external impact is weak. Therefore, the radome may be punctured when being impacted. To improve an impact resistance effect of the radome, currently, the impact resistance performance can be enhanced only by increasing the wall thickness of the radome. In this way, costs and the weight of the radome are inevitably increased significantly. This is not conducive to lightweight of the antenna system, and increases mounting and transportation costs.

FIG. 2 is a diagram of a simplified structure of a base station antenna according to an embodiment of this application. As shown in FIG. 2, the base station antenna includes a housing 22 and a radome 21. The housing 22 is connected to the radome 21 to form a sealing chamber 221, and the sealing chamber 221 accommodates a component of an antenna transmitting/receiving device, for example, an antenna board, a reflection board, a shielding cover board, or a TRX board. In an actual application process, the housing 22 and the radome 21 may be connected through a screw 23, and then sealed by using a sealing rubber strip.

Still as shown in FIG. 2, the radome 21 includes a main part and an extension part 213 formed by extending from the main part, and the radome 21 is connected to the housing 22 through the extension part 213. For example, a screw hole may be provided in the extension part, and correspondingly, a screw hole is also provided in an edge of the housing 22, and the extension part and the housing 22 are engaged after the screw passes through the screw holes.

A sealing groove 222 is provided in an edge of the housing 22, and the sealing rubber strip may be mounted in the sealing groove 222, to improve overall sealing performance of the base station antenna. During mounting, the radome 21 is covered on the housing 22, and the extension part 213 of the radome 21 and the housing 22 are tightly engaged through the screw 23. In addition to being connected through the screw 23, another connection manner, for example, a bonding connection manner, may alternatively be used. This may be selected based on an actual requirement, and is not limited herein.

As shown in FIG. 2, the radome has two functional surfaces. An outer surface is a protective surface, namely, a surface away from the sealing chamber 221. An inner surface is a waterproof surface, namely, a surface close to the sealing chamber 221. It can be understood that the outer surface of the radome bears maximum impact energy during a steel ball impact test or hoisting striking test.

To meet impact resistance requirements of the radome in the steel ball impact test and scenarios such as antenna transportation, moving, and mounting, as a weight of an antenna system increases, a wall thickness of the radome is generally increased to meet the impact resistance requirements. However, increasing the wall thickness of the radome is not conducive to lightweight of a product.

To resolve the foregoing technical problem, this application provides a lightweight radome 21 with strong impact resistance performance.

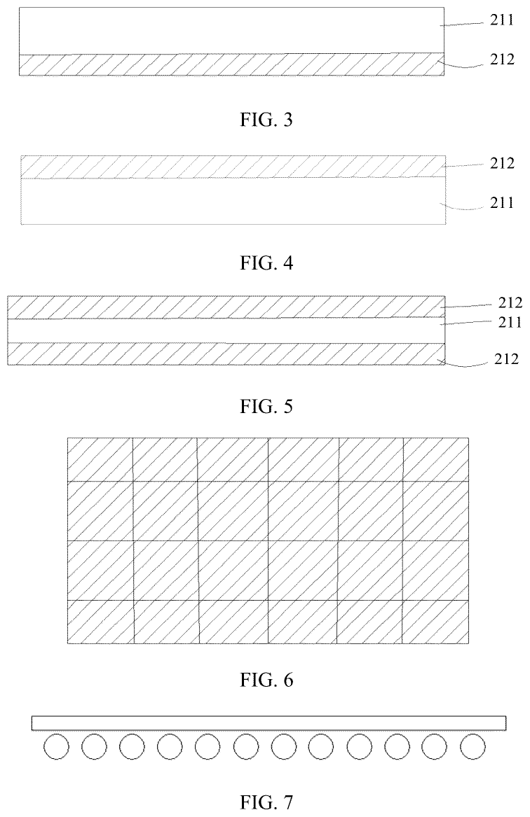

FIG. 3 is a diagram of a partial structure of a radome according to an embodiment of this application. As shown in FIG. 3, the radome 21 includes a substrate layer 211 and a reinforcement layer 212, and the reinforcement layer 212 is formed at least on an inner surface and/or an outer surface of the substrate layer 211. In this embodiment, the reinforcement layer 212 is formed on the inner surface of the substrate layer 211.

FIG. 4 is a diagram of another partial structure of a radome according to an embodiment of this application. As shown in FIG. 4, a reinforcement layer 212 is formed on an outer surface of a substrate layer 211, namely, a surface close to a sealing chamber 221.

FIG. 5 is a diagram of another partial structure of a radome according to an embodiment of this application. As shown in FIG. 5, a reinforcement layer 212 is formed on each of an outer surface and an inner surface of a substrate layer 211.

In some implementations, only thermoplastic resin may be used to form the substrate layer 211 through injection molding.

The thermoplastic resin in the substrate layer 211 includes at least one of polypropylene, polyethylene, polycarbonate, polyethylene terephthalate, polybutylene terephthalate, polyamide, polyphenyleneoxide, polyphenylene sulfide, polyetherimide, and poly(ether-ether-ketone) thermoplastic resin, which may be selected based on an actual requirement, and is not limited herein.

The reinforcement layer 212 includes a fiber layer and thermoplastic resin attached to the fiber layer, the fiber layer includes a first fiber, and a length of the first fiber is greater than or equal to 25 mm; and a material of the substrate layer 211 includes the thermoplastic resin, and the thermoplastic resin in the reinforcement layer 212 is made of a same material as the thermoplastic resin in the substrate layer 211.

In the foregoing solution, the reinforcement layer 212 is provided on the substrate layer 211 of the radome 21, and the reinforcement layer 212 includes the thermoplastic resin and the fiber layer. Compared with a single-material structure, a thickness and rigidity of the radome 21 are increased due to the substrate layer 211. The reinforcement layer 212 is made of a first fiber-reinforced composite material, so that good stress dispersion effect can be implemented when the radome is impacted. In addition, the first fiber is used as a framework of the reinforcement layer 212, so that higher impact resistance energy can be absorbed.

The substrate layer 211 provided in this application includes a thermoplastic resin layer. The thermoplastic resin is a large class of resin that can be repeatedly heated, softened, cooled, and cured. In a molding process, the resin is softened and flows after being heated and pressed, and may be formed in a mold. According to different characteristics, resin may be classified into thermosetting resin and thermoplastic resin. The thermosetting resin includes epoxy resin, cyanate ester resin, and the like; and the thermoplastic resin includes polypropylene, polyethylene, polyamide, and the like. In this embodiment, the radome 21 is produced by using the thermoplastic resin.

In some other implementations, the substrate layer 211 further includes the thermoplastic resin and a second fiber mixed in the thermoplastic resin, and a length of the second fiber is less than 25 mm.

The length of the second fiber may be specifically 24 mm, 20 mm, 15 mm, 10 mm, 5 mm, or the like. The second fiber may be a long fiber, or may be a short fiber. The long fiber and the short fiber are comparative concepts. The long fiber is arranged in a particle length direction of the thermoplastic resin. A fiber length is equal to or close to a particle length of the thermoplastic resin. The particle length of the thermoplastic resin may reach about 10 mm, and in this case, the length of the second fiber may also generally reach about 10 mm. The short fiber is distributed in the thermoplastic resin disorderly, a fiber length is generally less than 4 mm, and the length of the short fiber is less than the particle length of the thermoplastic resin. A class and the length of the second fiber may be specifically selected based on an actual requirement. This is not limited herein.

The thermoplastic resin in the reinforcement layer 212 is made of the same material as the thermoplastic resin in the substrate layer 211, so that resin compatibility between the reinforcement layer 212 and the substrate layer 211 can be improved, that is, the thermoplastic resin in the substrate layer 211 is better compatible with the thermoplastic resin in the reinforcement layer 212, to form a good butt-fusion interface, so as to achieve a good stress transfer function. In this way, the reinforcement layer 212 and the substrate layer 211 are not to be layered due to impact energy. Therefore, compared with a single-structure radome, a composite-structure radome in this application has a better impact resistance effect, and can reduce a wall thickness of the radome, to improve an impact resistance capability while implementing lightweight.

In a specific implementation, the fiber layer includes the first fiber, and the length of the first fiber may be specifically 25 mm, 30 mm, 35 mm, 40 mm, 45 mm, or the like. The first fiber may be directly obtained as follows: a fiber yarn in a roll is woven by a machine or a person to be a fiber cloth or a fiber layer arranged disorderly. Then, the fiber cloth or the fiber layer is impregnated, and the first fiber is not cut during an impregnation process. Therefore, the length of the first fiber may be specifically selected based on an actual requirement. To ensure rigidity and toughness required by the first fiber as the framework of the reinforcement layer 212, the length of the first fiber may be cut based on the actual requirement, provided that the length of the first fiber in a final product is greater than or equal to 25 mm. This is not limited herein.

In a specific implementation, the reinforcement layer 212 is a prepreg, and the prepreg is a sheet made by impregnating the first fiber or a first fiber woven fabric with the thermoplastic resin. Based on a finished product form of the prepreg, the prepreg can be divided into a prepreg cloth and a prepreg belt.

Based on an arrangement manner of first fibers in the reinforcement layer 212, the reinforcement layer 212 includes at least one of a woven fiber prepreg, a unidirectional fiber prepreg, and a fiber felt prepreg.

FIG. 6 is a diagram of an internal structure of a reinforcement layer of a radome according to this application. As shown in FIG. 6, a woven fiber prepreg includes a first fiber woven cloth and thermoplastic resin coating the first fiber woven cloth, that is, a layer of woven fabric formed by weaving first fibers is impregnated in organic resin to form the prepreg.

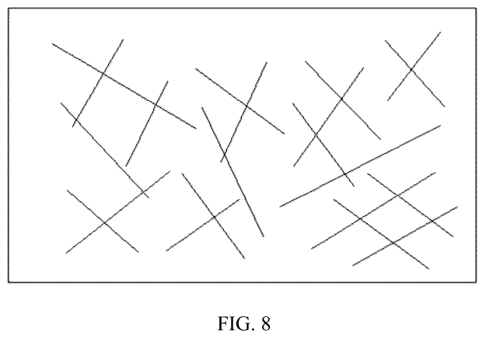

FIG. 7 is a diagram of an internal structure of another reinforcement layer of a radome according to this application. As shown in FIG. 7, a unidirectional fiber prepreg includes unidirectionally arranged first fibers and thermoplastic resin coating the unidirectionally arranged first fibers, that is, the first fibers are unidirectionally arranged and impregnated in organic resin to form the prepreg.

It should be noted that, in the unidirectional fiber prepreg, at least two layers of first fibers are arranged unidirectionally, that is, one layer of first fibers is arranged unidirectionally, and then another layer of first fibers is arranged at a converted angle. The two layers of first fibers are not interweaved. The converted angle may be 30°, 60°, 90°, 150°, or the like, which may be selected based on an actual requirement. This is not limited herein.

In some embodiments, FIG. 8 is a diagram of an internal structure of still another reinforcement layer of a radome according to this application. As shown in FIG. 8, a fiber felt prepreg includes disorderly arranged first fibers and thermoplastic resin coating the disorderly arranged first fibers, that is, the first fibers are disorderly arranged and impregnated in organic resin to form the prepreg.

The thermoplastic resin used in the reinforcement layer 212 in this application includes at least one of polypropylene, polyethylene, polycarbonate, polyethylene terephthalate, polybutylene terephthalate, polyamide, polyphenyleneoxide, polyphenylene sulfide, polyetherimide, and poly(ether-ether-ketone) thermoplastic resin, which may be selected based on an actual requirement, and is not limited herein.

In an optional technical solution of this application, the first fiber includes at least one of an inorganic fiber and an organic fiber. Specifically, the inorganic fiber includes at least one of a glass fiber, a basalt fiber, an andesite fiber, an aluminum silicate fiber, a boron nitride fiber, an alumina fiber, and a quartz fiber.

The organic fiber includes at least one of a polypropylene fiber, a polybutylene terephthalate fiber, a polyethylene terephthalate fiber, a poly trimethylene terephthalate fiber, a polyamide fiber, a polyphenylene sulfide fiber, a liquid crystal polymer fiber, a poly-p-phenylene benzobisoxazole fiber, a polybenzimidazole fiber, a polypyridobisinudazole fiber, and a polyimide fiber.

It should be noted that the inorganic fiber is characterized by a good mechanical property, small deformation, high use temperature, and excellent chemical stability. The organic fiber has excellent performance of low density and high strength. The organic fiber or the inorganic fiber may be selected based on an actual requirement. This is not limited herein.

To enable the produced radome 21 to also have lightweight performance, a gram weight of the first fiber is 200 g/m² to 1000 g/m². Optionally, the gram weight of the first fiber may be specifically 200 g/m², 400 g/m², 600 g/m², 800 g/m², 1000 g/m², or the like. Selection of the gram weight of the first fiber is related to a weight of an antenna. A larger weight of the antenna indicates a higher gram weight of the first fiber. Selection may be performed based on an actual requirement, and this is not limited herein. The gram weight of the first fiber is controlled within this range, so that an overall weight of a woven fiber prepreg, a unidirectional fiber prepreg, and a fiber felt prepreg formed by using the first fiber is reduced, and the produced radome 21 has lightweight and excellent impact resistance performance. Preferably, the gram weight of the first fiber may be 400 g/m² to 800 g/m².

To enable the radome 21 to also have the lightweight performance, a weight of the radome 21 may be further reduced by controlling thicknesses of the reinforcement layer 212 and the substrate layer 211.

Specifically, the thickness of the reinforcement layer 212 is 0.2 mm to 1 mm. Optionally, the thickness of the reinforcement layer 212 may be specifically 0.2 mm, 0.4 mm, 0.6 mm, 0.8 mm, 1.0 mm, or the like, which is not limited herein. If the reinforcement layer 212 is excessively thick, the produced radome 21 is excessively heavy and cannot meet a required lightweight requirement, which is inconvenient for mounting. If the reinforcement layer 212 is excessively thin, the produced radome 21 cannot achieve a good impact resistance effect, which affects a service life. Preferably, the thickness of the reinforcement layer 212 is 0.3 mm to 0.8 mm.

The thickness of the substrate layer 211 is 0.5 mm to 2 mm. Optionally, the thickness of the substrate layer 211 may be specifically 0.5 mm, 1.0 mm, 1.5 mm, 2.0 mm, or the like, which is not limited herein. If the substrate layer 211 is excessively thick, the produced radome 21 is excessively heavy and cannot meet a required lightweight requirement, which is inconvenient for mounting. If the substrate layer 211 is excessively thin, the produced radome 21 cannot achieve a good impact resistance effect, which affects a service life. Preferably, the thickness of the substrate layer 211 is 0.5 mm to 1.5 mm.

It should be noted that the impact resistance effect of the antenna provided in this application is mainly implemented by using the reinforcement layer 212. When the weight of the antenna increases, the thickness of the reinforcement layer 212 may be increased, and the thickness of the substrate layer 211 may be reduced.

Further, the substrate layer 211 used in this application has a porous structure. The porous structure may be formed, through foaming, by adding a chemical foaming agent to a thermoplastic resin material of the substrate layer, or the porous structure may be formed, through physically foaming, by introducing a gas like supercritical nitrogen gas or carbon dioxide gas into the substrate layer 211 in an injection molding process. An average pore size of the porous structure is less than or equal to 100 m. If a pore size of the porous structure is excessively large, an internal structure of the substrate layer 211 is unstable, and damage easily occurs in an impact process, which reduces the impact resistance performance of the radome 21.

A porosity of the substrate layer 211 is 10% to 30%. Optionally, the porosity of the substrate layer 211 may be specifically 10%, 15%, 20%, 25%, 30%, or the like. This is not limited herein. If the porosity of the substrate layer 211 is excessively large, and the porous structure is excessive, the internal structure of the substrate layer 211 is unstable, and damage easily occurs in the impact process. This reduces the impact resistance performance of the radome 21. If the porosity of the substrate layer 211 is excessively small, a weight of the substrate layer 211 cannot meet a required lightweight requirement. This is inconvenient for mounting.

Further, the substrate layer 211 used in this application may further include a hollow microsphere distributed in the thermoplastic resin. The hollow microsphere also helps meet the lightweight requirement of the substrate layer 211, and helps implement lightweight of the entire radome. Specifically, the hollow microsphere may be a hollow glass microsphere or a hollow ceramic microsphere.

In an actual application process, a volume proportion of the hollow microsphere in the substrate layer 211 is 10% to 50%, and an average particle size D50 of the hollow microsphere is less than or equal to 50 μm. Optionally, the volume proportion of the hollow microsphere may be specifically 10%, 20%, 30%, 40%, 50%, or the like, and the average particle size of the hollow microsphere may be specifically 10 μm, 20 μm, 30 μm, 40 μm, 50 μm, or the like. This is not limited herein. The substrate layer 211 includes the hollow microsphere, so that the weight of the radome 21 is further reduced while ensuring the impact resistance performance. If the volume proportion of the hollow microsphere is excessively large or the particle size of the hollow microsphere is excessively large, the structure of the substrate layer 211 is likely to be damaged in the impact process, and a good impact resistance effect cannot be achieved. If the volume proportion of the hollow microsphere is excessively small, the radome 21 cannot be light.

As shown in FIG. 3, this application further provides a method for producing a radome 21, including the following steps:

Step S1: Heat a prepreg to a temperature near a melting temperature of thermoplastic resin, to melt and soften thermoplastic resin on a surface.

Step S2: Place the prepreg into a front mold of a radome mold, and vacuumize to absorb and position the prepreg on an inner wall of the mold.

Step S3: Inject melted thermoplastic resin in an injection molding machine into a mold molding chamber, and demold after cooling, to obtain the radome 21.

It should be noted that the prepreg is at least one of a woven fiber prepreg, a unidirectional fiber prepreg, and a fiber felt prepreg.

The produced and molded radome 21 includes a substrate layer 211 and a reinforcement layer 212 formed on an inner surface of the substrate layer 211, to form the radome 21 of a double-layer composite structure. After the radome produced by using the method and a housing are assembled, when the radome is impacted by a hard object, the reinforcement layer formed on the inner surface of the substrate layer may deform, and good stress dispersion effect can be achieved when the radome is impacted. In addition, a fiber layer in the woven fiber prepreg is used as a framework of the reinforcement layer, to absorb higher impact resistance energy.

As shown in FIG. 4, this application further provides another method for producing a radome 21, including the following steps:

Step S1′: Heat a prepreg to a temperature near a melting temperature of thermoplastic resin, to melt and soften thermoplastic resin on a surface.

Step S2′: Place the prepreg into a rear mold of a radome mold, and vacuumize to absorb and position the prepreg on an inner wall of the mold.

Step S3′: Inject melted thermoplastic resin in an injection molding machine into a mold molding chamber, and demold after cooling, to obtain the radome 21.

The produced and molded radome 21 includes a substrate layer 211 and a reinforcement layer 212 formed on an outer surface of the substrate layer 211, to form the radome 21 of a double-layer composite structure. After the radome produced by using the method and a housing are assembled, when the radome is impacted by a hard object, the reinforcement layer formed on the inner surface of the substrate layer may deform, and good stress dispersion effect can be achieved when the radome is impacted. In addition, a fiber layer in the woven fiber prepreg is used as a framework of the reinforcement layer, to absorb higher impact resistance energy.

As shown in FIG. 5, this application further provides another method for producing a radome 21, including the following steps:

Step S1″: Heat a prepreg to a temperature near a melting temperature of thermoplastic resin, to melt and soften thermoplastic resin on a surface.

Step S2″: Place the prepreg into each of a front mold and a rear mold of a radome mold, and vacuumize to absorb and position the prepreg on an inner wall of the mold.

Step S3″: Inject melted thermoplastic resin in an injection molding machine into a mold molding chamber, and demold after cooling, to obtain the radome 21.

The produced and molded radome 21 includes a substrate layer 211 and a reinforcement layer 212 formed on an inner surface and an outer surface of the substrate layer 211, to form the radome 21 of a three-layer sandwiched composite structure. After the radome produced by using the method and a housing are assembled, when the radome is impacted by a hard object, the reinforcement layer formed on the inner surface of the substrate layer may deform, and good stress dispersion effect can be achieved when the radome is impacted. In addition, a fiber layer in the woven fiber prepreg is used as a framework of the reinforcement layer, to absorb higher impact resistance energy.

As an optional technical solution of this application, a weight ratio of the radome 21 produced in this application to an antenna system is 1:(10 to 50). Optionally, the weight ratio of the radome 21 to the antenna system may be specifically 1:10, 1:20, 1:30, 1:40, 1:50, or the like, which is not limited herein. The weight ratio of the radome 21 to the antenna system is controlled within this range, so that a requirement for impact resistance performance can be met while a requirement for lightweight is met.

Embodiments of this application are further described below by using a plurality of embodiments. Embodiments of this application are not limited to the following specific embodiments. Appropriate modifications may be made to implementation without departing from the scope of the claims.

### Embodiment 1

In Embodiment 1, a substrate layer is made of a second fiber-reinforced polypropylene material, a glass fiber with a length of 10 mm is used as a second fiber, and glass fibers are arranged in a particle length direction of polypropylene. A reinforcement layer is made of a woven fiber prepreg, namely, a first fiber-reinforced polypropylene composite material, and a glass fiber whose length is greater or equal to 25 mm is used as a first fiber, where the first fiber is a glass fiber, fiber lengths are respectively equivalent to a radome length and width, and a gram weight of the glass fiber is 420 g/m².

S1: Heat a glass fiber-reinforced polypropylene composite material sheet with a thickness of 0.5 mm to 165° C. to 230° C., to melt and soften thermoplastic resin on a surface of the sheet.

S2: Place the first fiber-reinforced polypropylene composite material sheet softened in S1 into a front mold of an antenna mold, and vacuumize to absorb and position the first fiber-reinforced polypropylene composite material sheet on an inner wall of the mold.

S3: Inject melted glass fiber-reinforced polypropylene material in an injection molding machine into a mold chamber with a thickness of 1.5 mm, and demold after cooling, to obtain a radome.

The radome includes the substrate layer and the reinforcement layer formed on an inner surface of the substrate layer. According to a test, the substrate layer is a dense structure, and a porosity is close to 0%.

### Embodiment 2

The following is different from Embodiment 1:

Step S2: Place the first fiber-reinforced polypropylene composite material sheet softened in S1 into a rear mold of an antenna mold, and vacuumize to absorb and position the first fiber-reinforced polypropylene composite material sheet on an inner wall of the mold.

### Embodiment 3

The following is different from Embodiment 1:

Step S2: Place the first fiber-reinforced polypropylene composite material sheet softened in S1 into each of a front mold and a rear mold of an antenna mold, and vacuumize to absorb and position the first fiber-reinforced polypropylene composite material sheet on an inner wall of the mold.

### Embodiment 4

The following is different from Embodiment 1:

In Embodiment 4, a substrate layer is made of a second fiber-reinforced polypropylene material, a glass fiber with a length of 10 mm is used as a second fiber, and glass fibers are arranged in a particle length direction. A reinforcement layer is made of a woven fiber prepreg, namely, a first fiber-reinforced polypropylene composite material, and a basalt fiber whose length is greater or equal to 25 mm is used as a first fiber, where lengths of basalt fibers are respectively equivalent to a radome length and width, and a gram weight of the basalt fiber is 440 g/m².

### Embodiment 5

The following is different from Embodiment 1:

In Embodiment 5, a substrate layer is made of a second fiber-reinforced polypropylene material, a glass fiber with a length of 10 mm is used as a second fiber, and glass fibers are arranged in a particle length direction. A reinforcement layer is made of a woven fiber prepreg, namely, a first fiber-reinforced polypropylene composite material, and a quartz fiber whose length is greater or equal to 25 mm is used as a first fiber, where lengths of quartz fibers are respectively equivalent to a radome length and width, and a gram weight of a quartz fiber plain cloth is 380 g/m².

### Embodiment 6

The following is different from Embodiment 1:

Step S3: Inject melted glass fiber-reinforced polypropylene material in an injection molding machine into a mold chamber with a thickness of 0.5 mm, and demold after cooling, to obtain a radome.

### Embodiment 7

The following is different from Embodiment 1:

Step S3: Inject melted glass fiber-reinforced polypropylene material in an injection molding machine into a mold chamber with a thickness of 2 mm, and demold after cooling, to obtain a radome.

### Embodiment 8

In Embodiment 8, a substrate layer is made of a second fiber-reinforced polypropylene material, a glass fiber with a length of 10 mm is used as a second fiber, and glass fibers are arranged in a particle length direction. A reinforcement layer is made of a unidirectional fiber prepreg, and three layers of prepregs are respectively paved according to 0°/90°/0°, namely, a first fiber-reinforced polypropylene composite material, and a glass fiber whose length is greater or equal to 25 mm is used as a first fiber, where lengths of glass fibers are respectively equivalent to a radome length and width, and a gram weight of the first fiber is 450 g/m².

### Embodiment 9

In Embodiment 9, a substrate layer is made of a second fiber-reinforced polypropylene material, a glass fiber with a length of 10 mm is used as a second fiber, and glass fibers are arranged in a particle length direction. A reinforcement layer is made of a fiber felt prepreg, namely, a first fiber-reinforced polypropylene composite material, and a glass fiber whose length is greater or equal to 25 mm is used as a first fiber, where the length of the glass fiber is 50 mm, and a gram weight of the first fiber is 450 g/m².

### Embodiment 10

The following is different from Embodiment 1:

S3: Inject melted glass fiber-reinforced polypropylene material in an injection molding machine into a mold chamber with a thickness of 1.5 mm, and demold after cooling, to obtain a radome.

The radome includes a substrate layer and a reinforcement layer formed on an inner surface of the substrate layer. According to a test, a porosity of the substrate layer is close to 10%.

### Embodiment 11

The following is different from Embodiment 1:

S3: Inject melted glass fiber-reinforced polypropylene material in an injection molding machine into a mold chamber with a thickness of 1.5 mm, and demold after cooling, to obtain a radome.

The radome includes a substrate layer and a reinforcement layer formed on an inner surface of the substrate layer. According to a test, a porosity of the substrate layer is close to 30%.

### Embodiment 12

The following is different from Embodiment 1:

In Embodiment 12, a substrate layer is made of a second fiber-reinforced polypropylene material, a glass fiber with a length of 10 mm is used as a second fiber, and glass fibers are arranged in a particle length direction of polypropylene. A reinforcement layer is made of a woven fiber prepreg, namely, a first fiber-reinforced polypropylene composite material, and a glass fiber whose length is greater or equal to 25 mm is used as a first fiber, where lengths of first fibers are respectively equivalent to a radome length and width, and a gram weight of the glass fiber is 420 g/m².

### Embodiment 13

The following is different from Embodiment 1:

In Embodiment 13, a substrate layer is made of a hollow microsphere-modified polypropylene material, a hollow microsphere is a hollow glass microsphere, a true density of the hollow microsphere is 0.6 g/cm³, and a volume proportion of the hollow glass microsphere is 30%. A reinforcement layer is made of a woven fiber prepreg, namely, a first fiber-reinforced polypropylene composite material, and a glass fiber whose length is greater than or equal to 25 mm is used as a first fiber, where lengths of first fibers are respectively equivalent to a radome length and width, and a gram weight of the glass fiber is 420 g/m².

The following is different from Embodiment 1:

S3: Inject melted glass fiber-reinforced polypropylene material in an injection molding machine into a mold chamber with a thickness of 1.5 mm, and demold after cooling, to obtain a radome.

The radome includes a substrate layer and a reinforcement layer formed on an inner surface of the substrate layer. According to a test, a porosity of the substrate layer is close to 30%.

### Comparison Example 1

In Comparison example 1, a substrate layer is made of a second fiber-reinforced polypropylene material, a glass fiber with a length of 10 mm is used as a second fiber, and glass fibers are arranged in a particle length direction.

S1: Inject melted glass fiber-reinforced polypropylene material in an injection molding machine into a mold chamber with a thickness of 3.3 mm, and demold after cooling, to obtain a radome.

TABLE 1
Test result parameter table of Embodiment 1 to Embodiment 11 (S1 to S11) and Comparison example 1 (D1)

| | Substrate layer | | | | Reinforcement layer | | | | |
|---|---|---|---|---|---|---|---|---|---|
| | | Glass fiber | | | | Gram weight | | | Impact |
| | | weight | | | | of a first | Prepreg | | resistance |
| | | proportion | Thickness | Porosity | | fiber | thickness | Radome | height |
| Sample | Material | (%) | (mm) | (%) | Material | (g/m²) | (mm) | weight | (m) |
| D1 | Glass | 30 | 3.3 | 0 | / | / | / | A | 1.3 |
| | fiber- | | | | | | | | |
| | reinforced | | | | | | | | |
| | polypropylene | | | | | | | | |
| | material | | | | | | | | |
| S1 | Glass | 30 | 1.5 | 0 | Glass | 420 | 0.5 (inner | 0.67 A | >1.3 |
| | fiber- | | | | fiber- | | surface) | | |
| | reinforced | | | | reinforced | | | | |
| | polypropylene | | | | polypropylene | | | | |
| | material | | | | composite | | | | |
| | | | | | material | | | | |
| S2 | Glass | 30 | 1.5 | 0 | Glass | 420 | 0.5 (outer | 0.67 A | >1.3 |
| | fiber- | | | | fiber- | | surface) | | |
| | reinforced | | | | reinforced | | | | |
| | polypropylene | | | | polypropylene | | | | |
| | material | | | | composite | | | | |
| | | | | | material | | | | |
| S3 | Glass | 30 | 1.5 | 0 | Glass | 420 | 1.0 (inner | 0.88 A | >1.3 |
| | fiber- | | | | fiber- | | surface + | | |
| | reinforced | | | | reinforced | | outer | | |
| | polypropylene | | | | polypropylene | | surface) | | |
| | material | | | | composite | | | | |
| | | | | | material | | | | |
| S4 | Glass | 30 | 1.5 | 0 | Basalt | 440 | 0.5 (inner | 0.68 A | >1.3 |
| | fiber- | | | | fiber- | | surface) | | |
| | reinforced | | | | reinforced | | | | |
| | polypropylene | | | | polypropylene | | | | |
| | material | | | | composite | | | | |
| | | | | | material | | | | |
| S5 | Glass | 30 | 1.5 | 0 | Quartz | 380 | 0.5 (inner | 0.65 A | >1.3 |
| | fiber- | | | | fiber- | | surface) | | |
| | reinforced | | | | reinforced | | | | |
| | polypropylene | | | | polypropylene | | | | |
| | material | | | | composite | | | | |
| | | | | | material | | | | |
| S6 | Glass | 30 | 0.5 | 0 | Glass | 420 | 0.5 (inner | 0.36 A | >1.3 |
| | fiber- | | | | fiber- | | surface) | | |
| | reinforced | | | | reinforced | | | | |
| | polypropylene | | | | polypropylene | | | | |
| | material | | | | composite | | | | |
| | | | | | material | | | | |
| S7 | Glass | 30 | 2 | 0 | Glass | 420 | 0.5 (inner | 0.82 A | >1.3 |
| | fiber- | | | | fiber- | | surface) | | |
| | reinforced | | | | reinforced | | | | |
| | polypropylene | | | | polypropylene | | | | |
| | material | | | | composite | | | | |
| | | | | | material | | | | |
| S8 | Glass | 30 | 1.5 | 0 | Glass | 450 | 0.5 (inner | 0.67 A | >1.3 |
| | fiber- | | | | fiber- | | surface) | | |
| | reinforced | | | | reinforced | | | | |
| | polypropylene | | | | polypropylene | | | | |
| | material | | | | composite | | | | |
| | | | | | material | | | | |
| S9 | Glass | 30 | 1.5 | 0 | Glass | 450 | 0.5 (inner | 0.67 A | >1.3 |
| | fiber- | | | | fiber- | | surface) | | |
| | reinforced | | | | reinforced | | | | |
| | polypropylene | | | | polypropylene | | | | |
| | material | | | | composite | | | | |
| | | | | | material | | | | |
| S10 | Glass | 30 | 1.5 | 10 | Glass | 420 | 0.5 (inner | 0.62 A | >1.3 |
| | fiber- | | | | fiber- | | surface) | | |
| | reinforced | | | | reinforced | | | | |
| | polypropylene | | | | polypropylene | | | | |
| | material | | | | composite | | | | |
| | | | | | material | | | | |
| S11 | Glass | 30 | 1.5 | 30 | Glass | 420 | 0.5 (inner | 0.53 A | >1.3 |
| | fiber- | | | | fiber- | | surface) | | |
| | reinforced | | | | reinforced | | | | |
| | polypropylene | | | | polypropylene | | | | |
| | material | | | | composite | | | | |
| | | | | | material | | | | |
| S12 | Polypropylene | 0 | 1.5 | 0 | Glass | 420 | 0.5 (inner | 0.56 A | >1.3 |
| | material | | | | fiber- | | surface) | | |
| | | | | | reinforced | | | | |
| | | | | | polypropylene | | | | |
| | | | | | composite | | | | |
| | | | | | material | | | | |
| S13 | hollow | 0 | 1.5 | 0 | Glass | 420 | 0.5 (inner | 0.53 A | >1.3 |
| | glass | | | | fiber- | | surface) | | |
| | microsphere- | | | | reinforced | | | | |
| | modified | | | | polypropylene | | | | |
| | polypropylene | | | | composite | | | | |
| | material | | | | material | | | | |

Impact resistance test: The radome is fully frozen at −40° C. At −40° C., a steel ball of 500 g is used to free fall at a height of 1.3 meters to impact a radome surface.

For the reinforcement layer in this application, the first fiber is used as a framework structure, so that stress can be fully transferred and dissipated. In this way, the reinforcement layer can bear greater impact energy. Composite injection molding is performed on the reinforcement layer and thermoplastic organic resin, to form a radome of a composite structure. Polypropylene resin in the substrate layer and polypropylene resin in the reinforcement layer are fused with each other, an interface bonding force is strong, and further, a stress transfer effect can be achieved. An impact resistance effect of the radome of this composite structure is far better than that of a radome obtained by using a single material of the glass fiber-reinforced polypropylene material. In addition, because the impact resistance energy is mainly absorbed by an inner thermoplastic polypropylene prepreg layer, the thickness of the substrate layer may be reduced, and content of the glass fiber may be further reduced, so that a significant lightweight effect can be achieved.

Impact resistance performance of radomes provided in Embodiment 1, Embodiment 2, Embodiment 4, and Embodiment 5 is significantly improved, and a requirement of a 40 kg-level antenna can be met. Compared with the weight of the radome in Comparison example 1, weights of the radomes are more than 30% lighter, and dielectric performance is excellent.

Compared with the radome provided in Embodiment 1, in a radome provided in Embodiment 3, a reinforcement layer is provided on each of an inner surface and an outer surface of a substrate layer, so that the radome has better impact resistance performance, and can support a requirement of a heavier antenna, but a weight is increased.

Compared with the radome provided in Embodiment 1, in the radome provided in Embodiment 6, a thickness of a substrate layer is reduced, and a weight of the radome is reduced, but impact resistance performance is reduced; and in the radome provided in Embodiment 7, a thickness of a substrate layer of the radome is increased, the weight of the radome is improved, and impact resistance performance is better than that of the radome provided in Embodiment 1.

Compared with the radome provided in Embodiment 1, in radomes provided in Embodiment 8 and Embodiment 9, the first fibers in the reinforcement layers are arranged in different manners, and impact resistance performance is reduced.

Compared with the radome provided in Embodiment 1, in the radomes provided in Embodiment 10 and Embodiment 11, the porosities of the substrate layers is increased, so that qualities of the radomes are reduced.

Compared with the radome provided in Embodiment 1, in the radome in Comparison example 1, the reinforcement layer is not produced, and impact resistance performance of the radome is reduced.

Compared with the radome provided in Embodiment 1, in the radomes provided in Embodiment 12 and Embodiment 13, material densities of the substrate layers are further reduced, and weights of the radomes are reduced, but impact resistance performance is reduced.

Although the example embodiments of this application are disclosed above, embodiments are not intended to limit the claims. Any person skilled in the art may make several possible changes and modifications without departing from the idea of this application. Therefore, the protection scope of this application shall be subject to the protection scope of the claims of this application.

What is claimed is:

1. A radome, wherein the radome comprises a substrate layer and a reinforcement layer, and the reinforcement layer is formed at least on an inner surface and/or an outer surface of the substrate layer; and
the reinforcement layer comprises a fiber layer and thermoplastic resin attached to the fiber layer, the fiber layer comprises a first fiber, and a length of the first fiber is greater than or equal to 25 mm; and the substrate layer comprises thermoplastic resin, and the thermoplastic resin in the reinforcement layer is made of a same material as the thermoplastic resin in the substrate layer.

2. The radome according to claim 1, wherein the reinforcement layer comprises at least one of a woven fiber prepreg, a unidirectional fiber prepreg, or a fiber felt prepreg.

3. The radome according to claim 1, wherein the first fiber comprises at least one of an inorganic fiber and an organic fiber.

4. The radome according to claim 1, wherein the inorganic fiber comprises at least one of a glass fiber, a basalt fiber, an andesite fiber, an aluminum silicate fiber, a boron nitride fiber, an alumina fiber, and a quartz fiber.

5. The radome according to claim 1, wherein the organic fiber comprises at least one of a polypropylene fiber, a polybutylene terephthalate fiber, a polyethylene terephthalate fiber, a poly trimethylene terephthalate fiber, a polyamide fiber, a polyphenylene sulfide fiber, a liquid crystal polymer fiber, a poly-p-phenylene benzobisoxazole fiber, a polybenzimidazole fiber, a polypyridobisinudazole fiber, and a polyimide fiber.

6. The radome according to claim 1, wherein a gram weight of the first fiber is 200 g/m² to 1000 g/m².

7. The radome according to claim 1, wherein a thickness of the reinforcement layer is 0.2 mm to 1 mm.

8. The radome according to claim 1, wherein a thickness of the substrate layer is 0.5 mm to 2 mm.

9. The radome according to claim 1, wherein the substrate layer further comprises a second fiber mixed in the thermoplastic resin, and a length of the second fiber is less than 25 mm.

10. The radome according to claim 1, wherein the thermoplastic resin comprises at least one of polypropylene, polyethylene, polycarbonate, polyethylene terephthalate, polybutylene terephthalate, polyamide, polyphenyleneoxide, polyphenylene sulfide, polyetherimide, and poly(ether-ether-ketone).

11. The radome according to claim 1, wherein the substrate layer is a porous structure, and a pore size of the porous structure is less than or equal to 100 m.

12. The radome according to claim 1, wherein a porosity of the substrate layer is 10% to 30%.

13. The radome according to claim 1, wherein the substrate layer further comprises a hollow microsphere mixed in the thermoplastic resin, and a volume proportion of the hollow microsphere in the substrate layer is 10% to 50%.

14. The radome according to claim 1, wherein an average particle size of the hollow microsphere is less than or equal to 50 m.

15. The radome according to claim 1, wherein a weight ratio of the radome to an antenna system is 1:(10 to 50).

16. A wireless communication system, wherein the wireless communication system comprises a radome comprises a substrate layer and a reinforcement layer, and the reinforcement layer is formed at least on an inner surface and/or an outer surface of the substrate layer; and
the reinforcement layer comprises a fiber layer and thermoplastic resin attached to the fiber layer, the fiber layer comprises a first fiber, and a length of the first fiber is greater than or equal to 25 mm; and the substrate layer comprises thermoplastic resin, and the thermoplastic resin in the reinforcement layer is made of a same material as the thermoplastic resin in the substrate layer.

17. The wireless communication system according to claim 16, wherein the reinforcement layer comprises at least one of a woven fiber prepreg, a unidirectional fiber prepreg, or a fiber felt prepreg.

18. The wireless communication system according to claim 16, wherein the first fiber comprises at least one of an inorganic fiber and an organic fiber.

19. The wireless communication system according to claim 16, wherein the inorganic fiber comprises at least one of a glass fiber, a basalt fiber, an andesite fiber, an aluminum silicate fiber, a boron nitride fiber, an alumina fiber, and a quartz fiber.

20. The wireless communication system according to claim 1, wherein the substrate layer further comprises a second fiber mixed in the thermoplastic resin, and a length of the second fiber is less than 25 mm.
